(19) United States
(12) Patent Application Publication
(10) Pub. No.: US 2011/0231415 A1
(43) Pub. Date: Sep. 22, 2011

(54) WEB PAGE SEARCHING SYSTEM AND METHOD USING ACCESS TIME AND FREQUENCY

(75) Inventor: Jang-Joong Kim, Seoul (KR)

(73) Assignee: ESTsoft Corp, Gwanak-gu (KR)

(21) Appl. No.: 13/130,777

(22) PCT Filed: Nov. 28, 2008
(86) PCT No.: PCT/KR2008/007019

§ 371 Date: May 24, 2011

(51) Int. Cl. G06F 17/30

(52) U.S. Cl. 707/752; 707/E17.104

(57) ABSTRACT

The present invention relates to a web search system and a method thereof based on a web page connection time and a web page visiting frequency. The web search system and the method thereof based on the web page connection time and the web page visiting frequency according to an embodiment of the present invention comprises the steps of: extracting the web page connection time of a user; calculating an accumulated connection time of the web page using the extracted connection time; and providing a list of web pages searched by the user after sorting the web pages in order of a ratio of the accumulated connection time.

### TECHNICAL FIELD

The present invention relates to a field of searching for a web page on the Internet, and more specifically, to a web search system and a method thereof based on a web page connection time and a web page visiting frequency extracted using a client program installed in a user terminal.

### BACKGROUND ART

Generally, a web page search field takes into account similarity, the number of links and the number of visitors of each web page in order to provide a search result.

Such a web page search field provides a search result having a further higher relationby providing a user with web pages containing a keyword inputted by the user, after sorting the web pages in order of the number of visitors, the number of links, or similarity.

However, the search method and apparatus based on the number of visitors, the number of links, or similarity are disadvantageous in that when a user accesses a web pageusing a title, summary information, or the like provided as a search result, they are reflected to the search result although the user may not obtain useful information from the accessed web page, and the degree of actually using the information on a web page cannot be correctly grasped and provided.

### DISCLOSURE OF INVENTION

### Technical Problem

Technical problem the present invention intends to solve is to present the web page searching system and method using access time and frequency being able to provide the user with a search result after grasping a degree of using information on a searched page.

### Technical Solution

The present invention has been made in order to solve the above problems, and it is an object of the invention to provide a web search system and a method thereof based on a web page connection time and a web page visiting frequency of a user, which provides the user with a search result after grasping a degree of using information on a searched page.

Another object of the invention is to provide a computer readable recording medium recorded with a program for executing the method in a computer.

In order to accomplish the above objects of the invention, according to one aspect of the invention, there is provided a web search method based on a web page connection time and a web page visiting frequency, the method comprising the steps of: (a) storing information on the connection time, i.e., a time period during which a specific web page is actually displayed on a specific user terminal, into the web search system; (b) calculating and storing, by the web search system, an accumulated connection time, i.e., a total time period during which the web page is displayed, by adding all time periods of the user terminal connected to the web page; and (c) providing, by the web search system, the user terminal with a list of web pages to which the user terminal has connected, after sorting the web pages in order of the accumulated connection time, wherein step (a) comprises the steps of: (a-1) measuring a web page active time extending from a time point of activating the web page to a time point of changing a web address or closing a web page window; (a-2) measuring a loss time extending from a time point of expiring a reference time to a time point of receiving a next input signal when an input device of the user terminal does not receive an input signal until the reference time is elapsed during the web page active time; and (a-3) calculating the connection time excluding the loss time from the web page active time.

According to another aspect of the invention, there is provided a web search method based on a web page connection time and a web page visiting frequency, the method comprising the steps of: (a) storing information on the connection time, i.e., a time period during which a specific web page is actually displayed on a specific user terminal, into the web search system; (b) calculating and storing, by the web search system, an accumulated connection time, i.e., a total time period during which the web page is displayed, by adding all time periods of the user terminal connected to the web page; and (c) providing, by the web search system, the user terminal with a list of web pages to which the user terminal has connected, after sorting the web pages in order of the accumulated connection time, wherein step (a) comprises the step of: (a-1) calculating the connection time by accumulating a time of inputting a valid signal through an input device while the user terminal is connected to the active web page.

The web search method further comprises the steps of: (d) calculating the visiting frequency, which is a ratio of the number of visits of the user terminal to the connection time; and (e) providing the list of web pages searched by the user terminal, after sorting the web pages in order of the visiting frequency.

The reference time is 1 to 3 minutes.

The web search method further comprises the steps of: (f) calculating the number of other web pages containing a link to the web page as a link popularity; (g) calculating frequency of a keyword contained in the web page as a similarity; and (h) providing the list of web pages searched by the user terminal, after sorting the web pages in order of a ratio of the link popularity and/or the similarity.

The web search method further comprises the steps of: (i) calculating a ratio of the accumulated connection time of the web page to an accumulated connection time of all web pages; and (j) providing the list of web pages searched by the user terminal, after sorting the web pages in order of the ratio of the accumulated connection time.

According to another aspect of the invention, there is provided a web search system based on a web page connection time and a web page visiting frequency, the system comprising: a web page use result database for receiving and storing information on the connection time, i.e., a time period during which a specific web page is actually displayed on a specific user terminal; and a central processing means for calculating an accumulated connection time, i.e., a total time period during which the web page is displayed on the user terminal by adding all time periods of the user terminal connected to the web page, storing the accumulated connection time in the web page use result database, and providing the user terminal with a list of web pages to which the user terminal has connected, after sorting the web pages in order of the accumulated connection time, wherein a client program measures a web page active time extending from a time point of activating the web page to a time point of changing a web address or closing a web page window; measures a loss time extending from a time point of expiring a reference time to a time point of receiving a next input signal when an input device of the user terminal does not receive an input signal until the reference time is elapsed during the web page active time; and calculates the connection time excluding the loss time from the web page active time.

According to another aspect of the invention, there is provided a web search system based on a web page connection time and a web page visiting frequency, the system comprising: a web page use result database for receiving and storing information on the connection time, i.e., a time period during which a specific web page is actually displayed on a specific user terminal; and a central processing means for calculating an accumulated connection time, i.e., a total time period during which the web page is displayed on the user terminal by adding all time periods of the user terminal connected to the web page, storing the accumulated connection time in the web page use result database, and providing the user terminal with a list of web pages to which the user terminal has connected, after sorting the web pages in order of the accumulated connection time, wherein a client program calculates the connection time by accumulating a time of inputting a valid signal through an input device while the user terminal is connected to the active web page.

The web page use result database further stores the web page visiting frequency, and the central processing means provides the list of web pages searched by the user terminal after sorting the web pages in order of the visiting frequency.

The web page use result database further stores a link popularity and/or a similarity of the web page, and the central processing means provides the list of web pages searched by the user terminal after sorting the web pages in order of the link popularity and/or the similarity.

According to still another embodiment of the present invention, there is provided a computer readable recording medium for executing the web search method in a computer.

### ADVANTAGEOUS EFFECTS

According to a web search system and a web search method of the present invention based on a web page connection time and a web page visiting frequency, a client program installed in a user terminal collects web addresses of web pages visited by a user, stores the collected information based on a connection time, visiting frequency, link popularity, and similarity of each web page, extracts web pages containing a keyword inputted by the user by the connection time, visiting frequency, link popularity and similarity, and provides the user with the extracted web pages, thereby providing a search result in ascending order of the degree of using the information on the web pages.

### BRIEF DESCRIPTION OF DRAWINGS

FIG. 1 is a view showing the system configuration of a web page search apparatus based on a connection time of each web page extracted using web page connection information of a user according to the present invention.

FIG. 2 is a flowchart illustrating a method of storing information based on a connection time of each web page extracted using web page connection information into a web page use result database according to the present invention.

FIG. 3 is graph showing a method of calculating a web page connection time of a user.

FIG. 4 is a view showing a record structure stored in the web page use result database.

FIG. 5 is a flowchart illustrating a method of providing a web page search result based on a connection time of each web page extracted using web page connection information of a user according to the present invention.

### MODE FOR THE INVENTION

Hereinafter, a web search system and a method thereof based on a web page connection time and a web page visiting frequency according to an embodiment of the present invention (hereinafter, referred to as a ‘web search system and a ‘web search method’) will be described with reference to the accompanying figures.

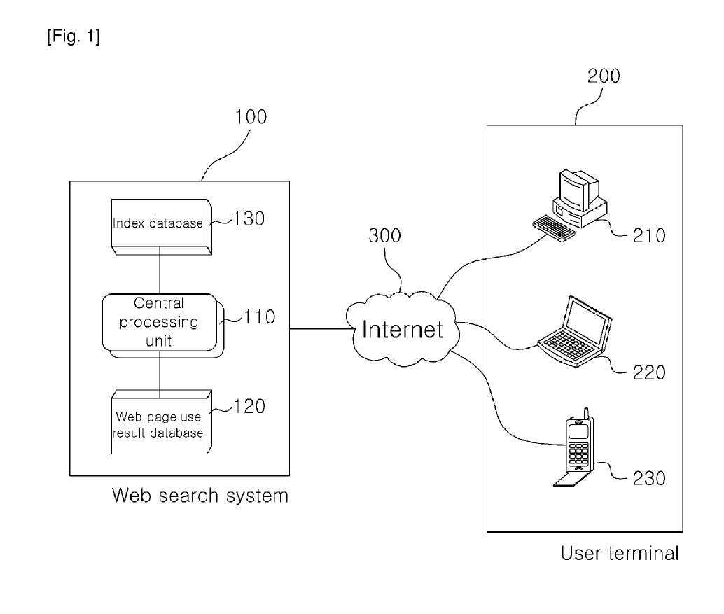

FIG. 1 is a view showing the system configuration of a web page search apparatus based on a connection time of each web page extracted using web page connection information of a user according to the present invention.

The web search system 100 of the present invention comprises a central processing unit 110, a web page use result database 120, and an index database 130. Although the web search system further comprises a variety of constitutional components for transmitting web search result data to the user terminal 200 connected through the Internet 300, such constitutional components are components of already publicized configurations, and thus detailed descriptions thereof will be omitted.

In order to use the search method of the present invention, a client program should be installed in the user terminal 200. The client program monitors a search process performed in the user terminal 200 and extracts data related to keywords frequently used by the user. The extracted data is transmitted to the web search system 100 of the present invention and utilized as a base data for providing a correct search result.

The user downloads and installs the client program in his or her terminal online or using a recording medium obtained offline. Since the client program should transmit the search result obtained by the user terminal 200 to the web search system 100, it is preferable to obtain a user's agreement when the client program is installed.

The web page use result database 120 stores web page use information of the user transmitted from the user terminal 200 installed with the client program.

The web page use information includes all sorts of information that can be obtained from the user terminal 200 through the client program, such as a web address, a visiting frequency, and a ratio of an accumulated connection time of a web page connected by the user terminal 200, in addition to a link popularity and similarity.

The index database 130 stores a keyword, a sentence or the like inputted by the user, together with a link to a URL of a web page containing a corresponding keyword, sentence, or the like. If the user inputs a keyword, a web page URL containing the keyword is extracted from the index database 130 and provided to the central processing unit 110.

The central processing unit 110 sorts the web page links received from the index database 130 based on the link popularity, similarity, visiting frequency, and ratio of accumulated connection time stored in the web page use result database 120 and provides a list of web pages searched by the user.

The operation of the web page use result database 120 according to the present invention configured as described above is described below.

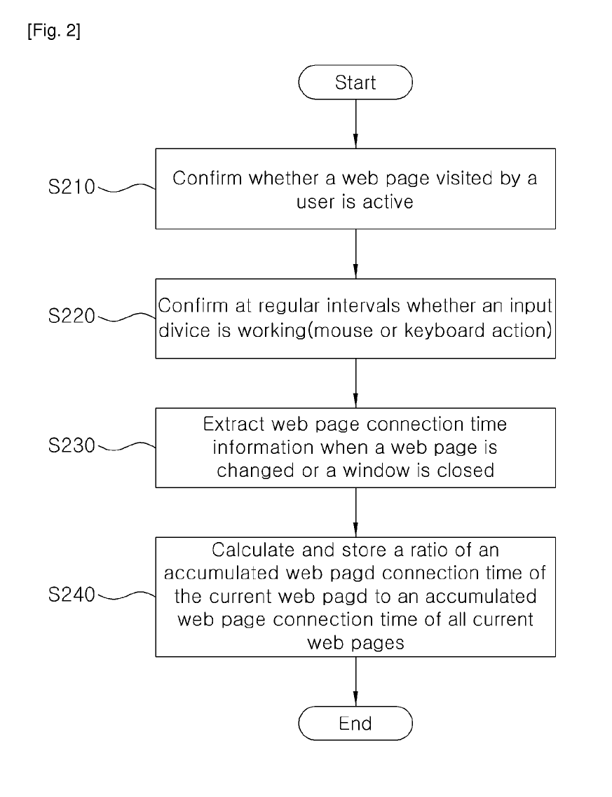

FIG. 2 is a flowchart illustrating a method of storing information based on a connection time of each web page extracted using the web page use information stored in the web page use result database 120 of FIG. 1.

If a user visits a web page, the client program of the user terminal 200 extracts information on the web address of the web page currently connected by the user terminal 200.

Then, the client program confirms whether the web page visited by the user is active S210. The fact that the web page is active means that the corresponding web page is displayed on the top window of the user terminal 200. If the web page is not displayed on the top window, but on a lower window, it means that the user does not see the window currently although the web page is displayed. Accordingly, whether or not a web page is active is an important factor for determining whether a user sees the web page.

Next, the client program confirms at regular intervals whether a signal is inputted through an input device of the user terminal 200 S220. The input device includes all kinds of apparatuses capable of receiving a user's input, such as a mouse, a keyboard, a tablet, and the like.

Next, the client program extracts a connection time of the web page visited by the user when the web address of the active web page is changed or the window of the web page is closed S230.

Then, a ratio of an accumulated connection time of the current web page to an accumulated connection time of a specific web page or an accumulated connection time of all web pages is transmitted to the web search system 100 and stored in the web page use result database 120 S240.

As another method, if the client program extracts and transmits information on a connection time to the web search system 100, the web search system 100 may calculate and store a connection time, an accumulated connection time, and a ratio of the accumulated connection time of a specific web page.

The method of extracting a connection time of a web page is as described below.

The client program installed in the user terminal 200 monitors whether a web page is active, whether a web address in the address window is changed, whether a window is closed, and whether the input device is operating. The client program measures a web page active time extending from a time point of activating the web page to a time point of changing the web address or closing the web page window. At this point, if an input is not received through the input device of the user terminal 200 for a predetermined period of time, the client program calculates a value excluding the time period (a loss time) as a connection time of a corresponding web page.

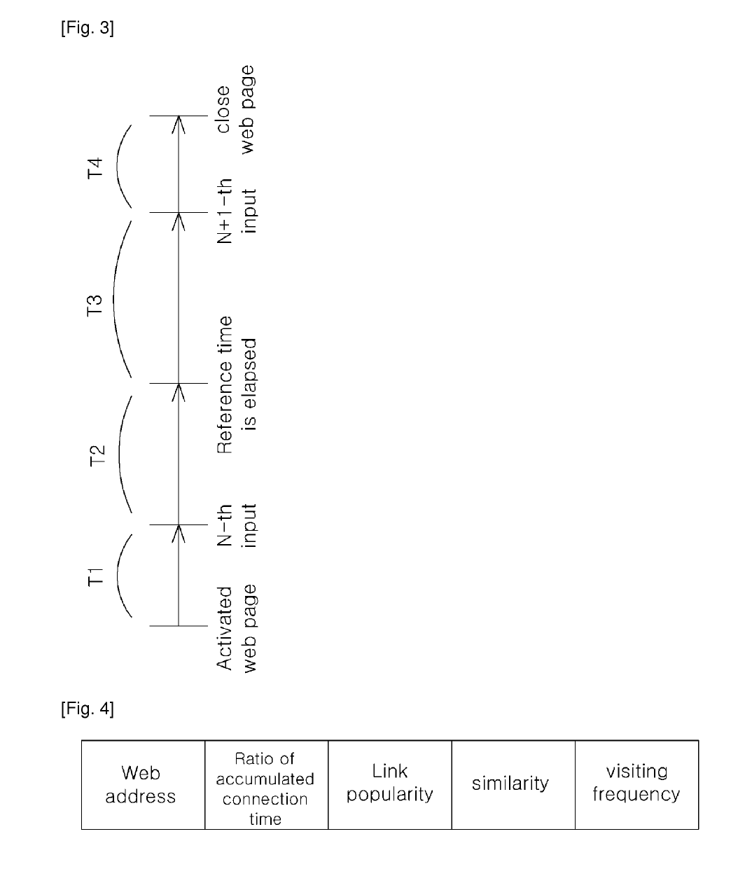

FIG. 3 is a graph showing a method of calculating a web page connection time of a user, and the method of calculating a web page connection time will be describe with reference to FIG. 3.

First, an active time of a specific web page is obtained by measuring a time period (T1+T2+T3+T4) extending from a time point of activating the web page to a time point of changing the web address or closing the window of the web page.

Then, it is determined whether a next input (n+1-th input) is received from a time point of receiving a previous input (n-th input) until a reference time T2 is elapsed through the input device while the web page is active.

If a signal is not inputted through the input device until the reference time is elapsed, it is determined that the user does not see the web page, and the loss time T3 extending from the time point when the reference time is elapsed until the next input (n+1-th input) is received is subtracted from the total connection time. Through the calculation described above, a time period of a user practically connected to the specific web page can be obtained.

This can be mathematically expressed as shown below.

Web page active time (T1+T2+T3+T4)−loss time during which a corresponding web page does not receive an input through an input device for more than a predetermined period of time (T3)=connection time (T1+T2+T4).

The reference time T2 for determining whether a signal is inputted can be varied depending on characteristics or features of a web page, the level of major users, and the like if such a method is used, and the reference time can be set to 1 to 3 minutes in the case of a web page of a general portal website.

As another method of extracting a connection time of a web page, an accumulated value of time when the user inputs a valid signal through the input device while the web page is active is extracted as the connection time.

The time of inputting a valid signal is a time of receiving an input through the input device within the reference time after the last input time.

A connection time is obtained by accumulating the time of inputting a valid signal through the input device while a web page is active until the web page is changed or the window is closed.

FIG. 4 is a view showing a record structure stored in the web page use result database 120, and each record includes a web address, a connection time, a ratio of accumulated connection time, link popularity, similarity and the number of visits.

The link popularity is the number of web pages linked to a corresponding web page in comparison with the number of web pages having a link connected from all web pages visited by a user of the user terminal 200 installed with the client program.

The similarity is frequency of a word contained in a web page and inputted by a user as a keyword.

The visiting frequency is frequency of using a web page visited by a user of the user terminal 200 installed with the client program. The client program increases the number of visiting the web page while monitoring whether the web address in the user terminal 200 is changed. When there are a large number of visits in a short connection time, rather than there are a small number of visits in a long connection time, a higher document weighting factor is applied, and the degree of using a document is measured high.

The visiting frequency is mathematically expressed as shown below.

Visiting frequency=(the number of visits/connection time)*k

Alternatively, a value of (the number of visits*k) can be used as a visiting frequency.

At this point, k is a certain real number for expressing the visiting frequency in a real value of 0 to 1.

The structure of the record stored in the web page use result database can be varied.

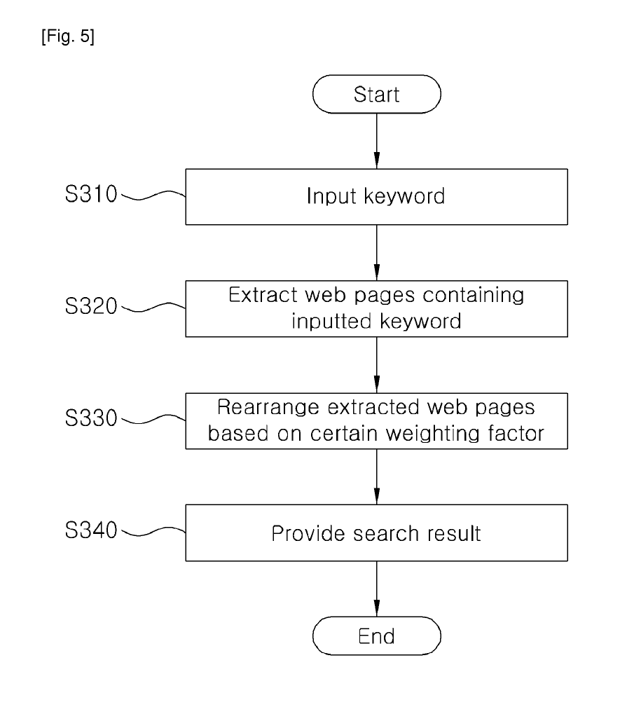

FIG. 5 is a flowchart illustrating a method of searching for a web page and providing a search result performed by a central processing unit 110 based on a an accumulated connection time of each web page extracted using web page connection information of a user according to an embodiment of the present invention.

If a user inputs a keyword 5310, the central processing unit 110 searches for web pages containing the inputted keyword and extracts the web pages from the index database 130 S320.

Then, the central processing unit 110 rearranges S330 and provides S340 the extracted web pages based on a document weighting factor comprising the ratio of the accumulated connection time, the link popularity, the similarity, and the visiting frequency stored in the web page user result database 120.

The visiting frequency is mathematically expressed as shown below.

Document weighting factor=a*ratio of accumulated connection time+b*link popularity+c*similarity+d*visiting frequency

Here, a, b, c, and d are set to make a+b+c+d 1.

The ratio of the accumulated connection time, the link popularity, the similarity, and the visiting frequency of the searched web pages are sorted in ascending order and expressed in a real value between 0 and 1. Values of a, b, c, and d representing a weight of a sorting result are set, and the central processing unit 110 rearranges a web page list based on a search result.

A document weighting factor of a past specific time period and a document weighting factor of a recent specific time period are measured, and a higher weighting factor can be applied to the document weighting factor of a recent specific time period.

That is, the visiting frequency can be calculated by discriminating a record of recent connections of visitors and a record of previous connections of the visitors in order to faithfully reflect popularity of the current web page.

For example, if the specific time period is set to a month and weighting factors of the past specific time period and the recent specific time period are set to 0.3 and 0.7 respectively, the document weighting factor can be obtained using the mathematical expression shown below.

Document weighting factor=0.3*document weighting factor of last one month+0.7*document weighting factor of recent one month.

Here, the ‘last one month’ is a month prior to the ‘recent one month’ going back from the current time point. That is, if today is Nov. 20, 2008, one month from October 20 to November 19 is the ‘recent one month’ and one month from September 20 to October 19 is the ‘last one month’.

Duration of a specific time period can be set with a different value.

For example, a document weighting factor of ‘recent three months’ is set to be different from a document weighting factor of ‘all time periods’ prior to the recent three months.

As is shown in the above example, if today is Nov. 20, 2008, a document weighting factor of the ‘recent three months from August 20 to November 19’ is multiplied by 0.7, and a document weighting factor of the ‘all time periods prior to August 19’ is multiplied by 0.3.

Latest data can be further more reflected by using the method described above.

The constant multiplied to the specific time period or the document weighting factor is merely an example, and a variety of constants can be applied considering characteristics of a web page, a level of visitors, a cycle of trends, or the like.

It is possible to set whether or not a weighting factor is applied to each of the ratio of the accumulated connection time, the link popularity, the similarity, and the visiting frequency, and then set weighting factors accordingly.

A method of searching for web pages based on the ratio of the accumulated connection time, the link popularity, the similarity, and the visiting frequency is described below with an example.

If a user inputs a keyword and searches for m web pages as a result of inputting the keyword, the searched web pages are sorted in ascending order of the ratio of the accumulated connection time, the link popularity, the similarity, and the visiting frequency, like N0, N1, . . . , N(m−1), and Nm, and a real value between 0 to 1 is set to each of the web pages.

If the document weighting factor is set by placing a higher weight on the ratio of the accumulated connection time and the similarity, like a=0.4, b=0.1, c=0.4, and d=0.1, the web page list is rearranged and provided depending on a result of setting the document weighting factor.

When a web page search result is provided, data sorted by any one of the connection time, the link popularity, the similarity, and the visiting frequency or data sorted by two or more of the connection time, the link popularity, the similarity, and the visiting frequency can be provided.

### INDUSTRIAL APPLICABILITY

Although the present invention has been described with reference to several preferred embodiments, the description is illustrative of the invention and is not to be construed as limiting the invention. Various modifications and variations may occur to those skilled in the art, without departing from the scope of the invention as defined by the appended claims.

1. A web search method based on a web page connection time and a web page visiting frequency, the method comprising the steps of:
(a) storing information on the connection time, i.e., a time period during which a specific web page is actually displayed on a specific user terminal, into the web search system;
(b) calculating and storing, by the web search system, an accumulated connection time, i.e., a total time period during which the web page is displayed, by adding all time periods of the user terminal connected to the web page; and
(c) providing, by the web search system, the user terminal with a list of web pages to which the user terminal has connected, after sorting the web pages in order of the accumulated connection time, wherein step (a) comprises the steps of:
(a-I) measuring a web page active time extending from a time point of activating the web page to a time point of changing a web address or closing a web page window;
(a-2) measuring a loss time extending from a time point of expiring a reference time to a time point of receiving a next input signal when an input device of the user terminal does not receive an input signal until the reference time is elapsed during the web page active time; and
(a-3) calculating the connection time excluding the loss time from the web page active time.

2. A web search method based on a web page connection time and a web page visiting frequency, the method comprising the steps of:
(a) storing information on the connection time, i.e., a time period during which a specific web page is actually displayed on a specific user terminal, into the web search system;
(b) calculating and storing, by the web search system, an accumulated connection time, i.e., a total time period during which the web page is displayed, by adding all time periods of the user terminal connected to the web page; and
(c) providing, by the web search system, the user terminal with a list of web pages to which the user terminal has connected, after sorting the web pages in order of the accumulated connection time, wherein step (a) comprises the step of:
(a-I) calculating the connection time by accumulating a time of inputting a valid signal through an input device while the user terminal is connected to the active web page.

3. The method according to claim 1, further comprising the steps of:
(d) calculating the visiting frequency, which is a ratio of the number of visits of the user terminal to the connection time; and
(e) providing the list of web pages searched by the user terminal, after sorting the web pages in order of the visiting frequency.

4. The method according to claim 1, wherein the reference time is 1 to 3 minutes.

5. The method according to claim 3, further comprising the steps of:
(f) calculating the number of other web pages containing a link to the web page as a link popularity;
(g) calculating frequency of a keyword contained in the web page as a similarity; and
(h) providing the list of web pages searched by the user terminal, after sorting the web pages in order of a ratio of the link popularity and/or the similarity.

6. The method according to claim 5, further comprising the steps of:
(i) calculating a ratio of the accumulated connection time of the web page to an accumulated connection time of all web pages; and
(j) providing the list of web pages searched by the user terminal, after sorting the web pages in order of the ratio of the accumulated connection time.

7. A web search system based on a web page connection time and a web page visiting frequency, the system comprising:
a web page use result database for receiving and storing information on the connection time, i.e., a time period during which a specific web page is actually displayed on a specific user terminal; and
a central processing means for calculating an accumulated connection time, i.e., a total time period during which the web page is displayed on the user terminal, by adding all time periods of the user terminal connected to the web page, storing the accumulated connection time in the web page use result database, and providing the user terminal with a list of web pages to which the user terminal has connected, after sorting the web pages in order of the accumulated connection time, wherein a client program measures a web page active time extending from a time point of activating the web page to a time point of changing a web address or closing a web page window; measures a loss time extending from a time point of expiring a reference time to a time point of receiving a next input signal when an input device of the user terminal does not receive an input signal until the reference time is elapsed during the web page active time; and calculates the connection time excluding the loss time from the web page active time.

8. A web search system based on a web page connection time and a web page visiting frequency, the system comprising:
a web page use result database for receiving and storing information on the connection time, i.e., a time period during which a specific web page is actually displayed on a specific user terminal; and a central processing means for calculating an accumulated connection time, i.e., a total time period during which the web page is displayed on the user terminal by adding all time periods of the user terminal connected to the web page, storing the accumulated connection time in the web page use result database, and providing the user terminal with a list of web pages to which the user terminal has connected, after sorting the web pages in order of the accumulated connection time, wherein a client program calculates the connection time by accumulating a time of inputting a valid signal through an input device while the user terminal is connected to the active web page.

9. The system according to claim 7, wherein the web page use result database further stores the web page visiting frequency, and the central processing means provides the list of web pages searched by the user terminal after sorting the web pages in order of the visiting frequency.

10. The system according to claim 9, wherein the web page use result database further stores a link popularity and/or a similarity of the web page, and the central processing means provides the list of web pages searched by the user terminal after sorting the web pages in order of the link popularity and/or the similarity.

11. A computer readable recording medium for executing the web search method claimed in claim 1 in a computer.

12. The method according to claim 2, further comprising the steps of:
(d) calculating the visiting frequency, which is a ratio of the number of visits of the user terminal to the connection time; and
(e) providing the list of web pages searched by the user terminal, after sorting the web pages in order of the visiting frequency.

13. The method according to claim 12, further comprising the steps of:
(f) calculating the number of other web pages containing a link to the web page as a link popularity;
(g) calculating frequency of a keyword contained in the web page as a similarity; and
(h) providing the list of web pages searched by the user terminal, after sorting the web pages in order of a ratio of the link popularity and/or the similarity.

14. The method according to claim 12, further comprising the steps of:
(i) calculating a ratio of the accumulated connection time of the web page to an accumulated connection time of all web pages; and
(j) providing the list of web pages searched by the user terminal, after sorting the web pages in order of the ratio of the accumulated connection time.

15. The method according to claim 2, wherein the reference time is 1 to 3 minutes.

16. The system according to claim 8, wherein the web page use result database further stores the web page visiting frequency, and the central processing means provides the list of web pages searched by the user terminal after sorting the web pages in order of the visiting frequency.

17. A computer readable recording medium for executing the web search method claimed in claim 2 in a computer.
